(19) United States
(12) Patent Application Publication
(10) Pub. No.: US 2012/0016943 A1
(43) Pub. Date: Jan. 19, 2012

(54) BARGAINED FOR EXCHANGE, GUIDED DISCOVERY AND DISPUTE RESOLUTION SYSTEM

(76) Inventors: Michael Ivan Greenberg, Miami, FL (US); John David Gardiner, Miami Beach, FL (US)

(21) Appl. No.: 13/182,312

(22) Filed: Jul. 13, 2011

Related U.S. Application Data
(60) Provisional application No. 61/364,014, filed on Jul. 13, 2010.

(51) Int. Cl. G06F 15/16

(52) U.S. Cl. 709/206

(57) ABSTRACT

A computerized system for the automated facilitation of the resolution of contractual and other disputes by communicating, processing, managing or guiding the process of dispute identification, discovery, negotiation and resolution through the Internet or other networked communications.

### FIELD OF THE INVENTION

The present invention in general relates to dispute resolution and in particular to a computerized system for the automated facilitation of the resolution of contractual and other disputes by communicating, processing, managing or guiding the process of dispute identification, discovery, negotiation and resolution through the Internet or other networked communications.

### BACKGROUND OF THE INVENTION

Historically, disputing parties have turned to the legal system for resolving disputes, while encountering time, knowledge, and expense hurdles. More and more, parties have sought out alternative dispute resolution processes to streamline the resolution of disputes and to save money. With the increased complexity of disputes, alternative dispute resolution processes are often perceived as costly. Parties may agree as part of a contract to resolve disputes through alternative means (such as arbitration or mediation, or automated means such as that described in U.S. Pat. No. 6,330,551 (Burchetta et al.), the rules associated with such means, or may otherwise agree to resolve any disputes through such means.

The process of dispute resolution constantly faces obstacles of timeliness, unnecessary escalation of the dispute to more costly, burdensome processes (i.e., contract termination, arbitration, and litigation), efficiencies, and required knowledge necessary to resolve even basic disputes. An informed discussion of such hurdles and one approach to resolving them in the context of construction projects is discussed as the “Resolex Approach” (Contracted Mediation, Dispute Resolution for Project-Based Industries, by Patrick Green and Stephan Woodward).

Disputes may be adversarial factual or legal disputes, or may be anticipated, non-adversarial steps in performance, such as the use of ‘punch lists’ for construction projects and ‘acceptance testing’ reports for software development.

In parallel with demands for innovative dispute resolution has been the significant adoption of online contracting tools, through networked computer systems that facilitate online signatures, client introductions and even contract negotiations and payment. These services (such as www.elance.com and www.guru.com) include some dispute resolution components, particularly where performance of an agreement is secured by third party escrow arrangements.

In each case under consideration, the initiation of the dispute gives rise to significant analysis and information needs to muster the materials necessary for third party Decision-Makers to resolve, mediate or moderate the dispute, whether by mediation, arbitration, judicial or regulatory body, or otherwise.

Thus, there exists a need to improve the cost-effectiveness of gathering, analyzing, prioritizing, and improving the quality of the information and analysis presented to Decision-Makers in order to facilitate rapid, high quality, lower cost resolution of disputes. The need to organize and prioritize information for dispute resolution is especially valuable where more and more information is being stored digitally, and new devices permit users to read digital media.

### SUMMARY OF THE INVENTION

Embodiments of the present invention provide a networked computer-based method and apparatus (“NCBMA”) for computer-assisted discovery and tribunals for disputes involving multiple parties. The system guides parties to work with asserted Points leading to conclusions with respect to such Points, such as by way of example in the litigation context, discovery, legal arguments and ultimate presentation of collections of arguments (more traditionally in the form of briefs) or otherwise to Decision-Makers leading to conclusions with respect to Points.

Through the use of NCBMA, embodiments of the invention streamline alternative dispute resolution processes by reducing the time, access, and expense hurdles for disputing parties, and potentially enabling practically “real-time” resolution of disputes/questions. In addition, the use of networked computer systems in embodiments act to eliminated the need for parties to meet physically in order to resolve disputes. Disputing parties can therefore utilize networked computer systems to present their cases to each other, narrow issues where they may collaboratively reach consensus, and ultimately submit more efficient electronic representations of their evidence and arguments to Decision-Makers. The Decision-Makers may also consider non-electronic evidence, to the extent permitted by applicable Rules.

Embodiments of the present invention address the issue of organizing increasing quantities and varieties of information, in a tool that is accessible, understandable and usable by consumers and more sophisticated parties alike, whether or not represented by counsel. The present invention also addresses the streamlining of the delivery, organization and retrieval of such information by Decision-Makers in such a manner that decisions can be made efficiently, effectively and economically, and the needs for such decision-making is minimized as party's exchange information and weigh the merits of alternative positions.

In embodiments of the invention a NCBMA facilitates unilateral and collaborative efforts between two or more parties involved in disputes (or otherwise seeking to resolve the answer to a question, optionally put to a final decision or conclusion, such as academic or non-academic research questions, and corporate governance decision-making depending on information from multiple sources), with the intended outcome of such efforts being the prioritization by each party (a “party” including any source of information made available to Decision-Makers) and/or the parties collaboratively of the relative importance of identified information to each dispute/question, the documentation of consensus or failures to achieve consensus on issues related to each dispute/question, and systems and methods to cost-effectively manage the delivery, organization and retrieval of the information by Decision-Makers.

With respect to disputes arising from legal agreements, embodiments of the invention may be integrated with systems for managing the negotiation, execution, amendments to such agreements, such that the present invention facilitates management of performance and compliance with the agreements. Furthermore, these systems may provide the means to efficiently and expeditiously provide significant information relevant to the dispute and facilitate performance of the terms and conditions of awards, settlements and any other resolutions of disputes. By integrating the inventive system into the legal agreements, the resolution of any disputes becomes a component of the agreements and an obligation that must be performed by each party. However, integration of embodiments with such systems is not necessary to utilize the present invention as the parties can identify and provide the information related to the negotiation, execution, amendments to such agreements for the purpose of resolving any particular dispute/question.

Embodiments of the invention combine the use of the NCBMA for managing contract, economic terms, and delivery of and signatures for agreements, payment escrow and payment processing (herein referred to as “Bargained For Exchange” systems or simply “BFE”) with dispute resolution components. A BFE consists of NCBMA for parties to propose, counter-propose, sign, revise, track performance, manage specification, purchase and delivery of materials, deliverables and otherwise manage the contracting and payment and escrow of payment processes, including current and future means of accomplishing all or portions of the foregoing. Through BFE, multiple parties reach binding agreements, when all such parties electronically sign the same proposed agreement (via any means of electronic approval or signature permitted by an applicable jurisdiction) or otherwise provide binding assent.

### BRIEF DESCRIPTION OF THE DRAWINGS

FIG. 1 is a block diagram of components of an embodiment of the invention;

FIG. 2 is a flowchart illustrating the initiation of a dispute within or by the Guided Discovery System according to an embodiment of the invention;

FIG. 3. is a flowchart illustrating the decision making process carried out by Decision-Makers according to an embodiment of the invention;

FIG. 4 is a schematic diagram illustrating an overall view of communication devices, computing devices, and mediums for a networked computer-based method and apparatus for computer-assisted discovery and tribunals for disputes involving multiple parties according to embodiments of the invention.

### DETAILED DESCRIPTION OF THE PREFERRED EMBODIMENTS

Glossary of Terms

BFE—Bargained for Exchange system for negotiation, execution, amendment, settlement and providing means to identify disputed terms.
Decision-Makers are mediators, arbitrators, arbitrator panels, judges, magistrates and any other person involved in deciding the resolution of a Point.
Discoverable Content is identified data (i.e., Docs) within a BFE and Guided Discovery systems that are Discoverable (generally the other part(ies) have a right of access to that data) as opposed to assumed or irrevocably “non-Discoverable Content” in adversarial proceedings such as an arbitration or court proceeding. Non-Discoverable content often includes, by way of example, communications related to settlement negotiations. Similarly, preferably, information created or presented within a mediation would default to or irrevocably be assigned to be non-Discoverable Content. Similarly, in non-adversarial settings, Content, including by way of communications, may nevertheless be identified as private information or communications not intended to be included in the collaborative aspects of the Guided Discovery process. For purposes of this definition, Non-Discoverable communications include privately stored notes and draft Docs and responses created by one party, unless communicated to other party(ies).
Docs are digital materials, deliverables, text, digital audio, digital audio/video content, and any other media, and any reference to any other content or media, such as elements of a contract stored within a BFE or other system, and any metadata associated with any of the foregoing. Docs may also take the form of a request for production, including an electronic survey (acting as a form of interrogatory in a litigation setting). Questions in such surveys ideally reference Docs and other objects as appropriate, and responses similarly reference Docs and other objects as appropriate. Such references result in a special application of Relationships.
Interfaces are user, data, software or other interfaces, imported (through standard means) data, web services, databases (including multiple systems or components sharing data storage) or other standard means for introduction and retrieval of data, and initiation of NCBMA processes by, from and into a NCBMA, including user interfaces.
NCBMA—A networked computer-based method and apparatus.
Points are questions, factual assertions or other information that may be subject to discussion, analysis or proof. Point creation can be made user friendly by use of wizards, ideally using options relevant to the type of contract and other context. Such a system can adapt to actual choices made by other users with similar contexts. Such a system could automate generation of prompts, or suggest new prompts for approval by system users. Users also could customize the prompts to meet their specific needs, particularly for users engaging in multiple contracts with similar contexts.
Point Conclusions are articulated answers, assertions, stipulations or other appropriate conclusions (including clarifications of agreements or disagreements with such conclusions by parties or Decision-Makers).
Tribunals are groups of individuals, peer review, mediation, arbitration, court and any other forum, such as for research or any other issue resolution. Consequently, the present invention may be used in a broad set of circumstances, including mediation, arbitration, research, and to provide for virtualized jury ‘trials’ and related voting.

Embodiments of the present invention facilitate early, cooperative resolution of issues being disputed between and among parties. The present invention does so through two primary means—first by providing an automated means that uses non-traditional rules and tools that encourage cooperative discovery and collaborative vetting of factual, legal and logical arguments. By doing so, the inventive system greatly improves the efficiency of submitting data (argument) to Decision-Makers, the quality of data (argument) submitted to Decision-Makers (arbitration panels, judges etc.), thereby equalizing the parties' ability to present arguments and control dispute resolution costs. Second, the invention does so by permitting integration with current and future automated systems that manage contracts. These automated systems may do so considering a contract a single item of electronically stored data, or representing the contract as data or metadata at varying levels of granularity (i.e., the Bargained For Exchange system described herein), and in each case may provide payment systems and/or digital signature retention related to the contract. In any case, these systems provide useful data that may be offered as proof within a dispute, and the contract, data and metadata may be identified with specificity determined by the contract system, providing specific context to reduce ambiguities with regard to a dispute and reduce the time required by the parties and Decision-Makers to retrieve and analyze related information.

Embodiments of the present invention transform disputes into productive processes of contract fulfillment, in particular for contracts that proceed over non-trivial time periods and that typically result in deviations from contract requirements. Circumstances of contract use that involve deviations from contract requirements or specifications are typical of construction, software and many other industries and services. The invention may be utilized as part of a BFE's processes or may be included by parties in a written contract as the process through which any disputes will be resolved. In both cases, embodiments of the invention become an affirmative obligation by all parties to the contract to resolve their disputes through the efficient, effective and economical invention.

Embodiments of the present invention may also be applied to any other factual, logical or investigative issue or issues, including by way of example, torts, regulatory disputes, research and education. In such cases, some or all of the participants and/or third parties may each be Decision-Makers, with means for multiple Decision-Makers to jointly reach a decision (such as by majority or unanimous vote on all Points together, groups of Points or specific Points).

In embodiments of the present invention, systems and processes are provided for guided discovery and dispute resolution (“Guided Discovery”) throughout the life-cycle of a dispute, including initiation of disputes, discovery, articulation of arguments (briefing), and rendering of decisions. Guided Discovery also provides the means to automate offers of settlement, and automation of payments upon a settlement, judgment or award following a Decision. Interfaces of the embodiments with online contract management and/or online payment processing systems, and the ability of embodiments to specify the resolution of the dispute with specificity (i.e., the amount of any monetary payment or Amendment to an agreement) greatly enhance each of the foregoing capabilities.

Embodiments of the present invention provide a networked computer-based method and apparatus (“NCBMA”) for computer-assisted discovery and tribunals for disputes involving multiple parties. The system guides parties to work with asserted Points leading to conclusions with respect to such Points, such as by way of example in the litigation context, discovery, legal arguments and ultimate presentation of collections of arguments (more traditionally in the form of briefs) or otherwise to Decision-Makers leading to conclusions with respect to Points.

Through the use of NCBMA, embodiments of the invention streamline alternative dispute resolution processes by reducing the time, access, and expense hurdles for disputing parties, and potentially enabling practically “real-time” resolution of disputes/questions. In addition, the use of networked computer systems in embodiments act to eliminated the need for parties to meet physically in order to resolve disputes. Disputing parties can therefore utilize networked computer systems to present their cases to each other, narrow issues where they may collaboratively reach consensus, and ultimately submit more efficient electronic representations of their evidence and arguments to Decision-Makers. The Decision-Makers may also consider non-electronic evidence, to the extent permitted by applicable Rules.

Embodiments of the present invention address the issue of organizing increasing quantities and varieties of information, in a tool accessible, understandable and usable by consumers and more sophisticated parties alike, whether or not represented by counsel. The present invention also addresses the streamlining of the delivery, organization and retrieval of such information by Decision-Makers in such a manner that decisions can be made efficiently, effectively and economically, and the needs for such decision-making is minimized as party's exchange information and weigh the merits of alternative positions.

In embodiments of the invention a NCBMA facilitates unilateral and collaborative efforts between two or more parties involved in disputes (or otherwise seeking to resolve the answer to a question, optionally put to a final decision or conclusion, such as academic or non-academic research questions, and corporate governance decision-making depending on information from multiple sources), with the intended outcome of such efforts being the prioritization by each party (a “party” including any source of information made available to Decision-Makers) and/or the parties collaboratively of the relative importance of identified information to each dispute/question, the documentation of consensus or failures to achieve consensus on issues related to each dispute/question, and systems and methods to cost-effectively manage the delivery, organization and retrieval of the information by Decision-Makers.

With respect to disputes arising from legal agreements, embodiments of the invention may be integrated with systems for managing the negotiation, execution, amendments to such agreements, such that the present invention facilitates management of performance and compliance with the agreements, and such systems provide the means to efficiently and expeditiously provide significant information relevant to the dispute and facilitate performance of the terms and conditions of awards, settlements and any other resolutions of disputes. By integrating the inventive system into the legal agreements, the resolution of any disputes becomes a component of the agreements and an obligation that must be performed by each party. However, integration of embodiments with such systems is not necessary to utilize the present invention as the parties can identify and provide the information related to the negotiation, execution, amendments to such agreements for the purpose of resolving any particular dispute/question.

Embodiments of the invention combine the use of the NCBMA for managing contract, economic terms, and delivery of and signatures for agreements, payment escrow and payment processing (herein referred to as “Bargained For Exchange” systems or simply “BFE”) with dispute resolution components. A BFE consists of NCBMA for parties to propose, counter-propose, sign, revise, track performance, manage specification, purchase and delivery of materials, deliverables and otherwise manage the contracting and payment and escrow of payment processes, including current and future means of accomplishing the foregoing. Through BFE, multiple parties reach binding agreements, when all such parties electronically sign the same proposed agreement (via any means of electronic approval or signature permitted by an applicable jurisdiction) or otherwise provide binding assent. It is noted that BFE of embodiments may include more or less functionality than that described herein, but minimally identifies the agreement and parties to the agreement.

Utilizing a NCBMA in embodiments, parties may select one or more milestones, deliverables or other terms, conditions, data and metadata, represented in an agreement (each an “Object”). The BFE system provides a means to identify one or more Objects as the subject of a dispute, minimally the agreement itself (if a contractual dispute) or expose the objects through an Interface for reference from the Guided Discovery system. More generally, parties may identify a dispute by general references or descriptions of the dispute, and claims raised in the dispute (each claim being a “Point” as discussed below). Further, disputes may be raised external to the BFE by requesting objects or references to them from the BFE.

In embodiments, Guided Discovery preferably begins with the identification of the topics of a dispute. This may occur by identifying content or objects within a BFE or other system, or through other standard means of entering a description, or combinations of these. For example, a party to a BFE may initiate disputes using “Dispute This” buttons available for identifiable objects or content within a BFE such as a payment terms, milestones or deliverables, or most often breached issues such as “Non-Delivery”, “Non-Payment”, with Relationships to relevant data. Alternatively or additionally, in this example, a party to a BFE may provide a “Dispute Now” button that then provides the means for the user to select objects or content within a BFE, or raise disputes that do not relate to objects or content. Similarly, disputes may be raised without reference to a BFE, with a party initiating the dispute if provided in their agreement with the other party(ies), or if not provided in a contract by the parties mutually agreeing to using the present invention.

In embodiments when initially identifying a dispute and any time during the dispute process, a party, when working within a BFE, may also offer proposed resolutions of the dispute as proposed amendments to a contract in a BFE or as a new contract within a BFE (i.e., a settlement). When such settlements become binding, the dispute process preferably automatically terminates, a process that may be initiated by a BFE through an Interface to document within the Guided Discovery system the settlement of the dispute, or by data stored within and specifying such resolution agreed upon by the parties within the Guided Discovery system, or specified by a Decision-Maker with that system. That is, the system (BFE, Guided Discovery system or other system) through which the settlement is recorded may communicate through an Interface with the Guided Discovery System and optionally other systems the fact of the resolution (ensuring that the dispute will be terminated) and optionally additional data related to the resolution of the dispute.

Similarly, when using embodiments of a BFE, mediators may propose and third parties (with authority to render binding decisions) may dictate, the terms of a recommendation or decision by which a dispute is resolved or settled. Such terms may be articulated directly within a BFE as amendments to existing agreements or as new agreements, and where a dispute has been raised concerning an agreement for which funds are escrowed in a BFE, automate the disbursement of funds in escrow. For example, an amendment or award might reduce the required escrow amount to zero, in which case the escrow funds may be automatically (or via a standard work flow process) released to the customer; or increased, in which case the system may automatically request additional funds of the customer.

In embodiments with respect to proposed settlements of disputes, each party must electronically sign an amendment(s) approving identical versions of proposed settlements. However, a third party Decision-Maker with authority to render a binding decision may dictate the terms of the binding amendment(s) within a BFE. Such dictated decisions may optionally provide additional work flow to permit the parties to appeal the conclusions and accuracy of the dictated terms.

In whatever manner a dispute is raised, the Guided Discovery system provides the means to store, manage and present Docs and to raise, discuss, and seek consensus on Points. Docs provide the subject matter and supporting materials for organizing discussions of Points. In the context of mediation and arbitration, and litigation (i.e., court or regulatory proceedings), Guided Discovery provides an enhanced means for Decision-Makers to browse, search and organize materials presented. Embodiments of a Guided Discovery system may optionally limit the Docs and Points presented to Decision-Makers, requiring parties to provide focused arguments and the most relevant evidence in the form of Docs. The system therefore permits Rules to be defined to impose limitations, including by way of example, number and size of Docs per Point, and in aggregate, and limitations on time to respond to messages (the communication of information during the Guided Discovery and Decision-Making processes) and total time before automatic closing of discussion of Points. The Guided Discovery system may also impose different limitations for guided discussions between the parties than are imposed on final submissions of Docs and Points by the parties to Decision-Makers, storage used. The Guided Discovery system may permit exceptions agreed upon by the parties, or as determined by a Decision-Maker (which may or may not be the Decision-Maker with respect to Point Conclusions).

Embodiments of the present invention may also include a means to calculate Decision-Maker fees and fees for use of the service based on data determined within the Guided Discovery system, such as the quantity of data submitted to Decision-Makers by each party, alone or in combination with more traditional means of calculating fees such as time spent by Decision-Makers. Ideally, parties would agree to set quantities of information based on pages or page-equivalents (for each other type of data), optionally permitting additional pages or page-equivalents at a higher per-page fee to discourage unnecessary submissions to the Decision-maker. Content equivalents take the form of Commerce Rules such as translating video clips into an equivalent number of pages (or other standard measure(s)) (i.e., x seconds of video equals y pages). Similarly, the number and size of graphics (including photos), diagrams, simulations and any other content may be converted into an equivalency measure for purposes of managing Limitations Rules and Commerce Rules applicable to such content. Similarly, charges by Decision-Maker's may include measures based on content actually accessed and times accessing the content. The result of such Rules is the ability to encourage productive, cost-effective behaviors (i.e., optimizing the quality of the content submitted to a Decision-Maker), providing more fair and accurate fee measures, and as a result expediting the decision-making process.

Embodiments of the Guided Discovery provide a means for parties to engage in documented discussions of Points and reference Docs. The discussions may be as basic as commonly used threaded discussions. Preferably, these discussions categorize at each step the nature of the content presented by a party, and maintain statuses with respect to each Point. In particular, a Point may be open, closed, and with respect to a closed Point, the parties may have indicated agreement or disagreement with a Point. Where the parties disagree, alternative Points may be presented by the parties. In each case, optionally the parties may qualify their agreement or disagreement and optionally the parties may prioritize the Docs they desire to be submitted to the Decision-Maker with the Point, which may be subject to limitations established for the dispute. The system further assists such prioritization by presenting the impact on limitation Rules, such as space (page) limitations and limitations on the number of Points raised by each party. The parties optionally may prioritize at any time before ‘publication’ of content to Decision-Makers.

Points may be organized in various standard means, such as hierarchically, by tags or by presenting relationships between Points, optionally stating the nature of the relationship as a text or logical statement or proposition (i.e., Point 1 is true only if related Point 2 is true), or even Non-Discoverable Data such as relevance weightings used by a party for their own use. Logical propositions represented within a Point may be created through user-friendly user interfaces (UI) that help the party build the proposition from available Docs, and Relationships to Docs and other objects. Such relationships between Points may optionally impose logical consistency (i.e., optionally impose a condition such as to not allow Point 1 to be agreed upon unless Point 2 is agreed upon).

As a consequence of the limitation Rules outlined above or the actions of the parties or Decision-Makers, Points are closed and the parties will have prioritized the Points and Docs supporting Points that they desire to be submitted to the Decision-Makers. When a dispute has had its Points and Docs supporting Points prioritized, the dispute is submitted to the Decision-Makers by ‘publication’. Publication provides online and optionally printed versions of the published content. Online access has the advantage of searching, branching following relationships and threaded messages, of the published content. Additionally, the Decision-Makers may reorganize the published content, request additional content (where permitted by the Rules) from parties, and store notes and draft Point Conclusions. Ultimately, the Decision-Maker publishes any conclusions with respect to published Points and optionally new Points raised by the Decision-maker, along with Point Conclusions. When the Decision-Maker interfaces with a BFE, the Decision-Maker may also implement the decision as contract amendment, which may include escrow release requirements or other payment terms.

Objects within the Guided Discovery system, such as Rules, Docs, Points, Messages and Relationships, preferably have unique identifiers (preferably GUIDs) and preferably the Guided Discovery system maintains versions of each object, preferably including audit records of all creation, access to, reads of and revisions of such objects. Rules may define each party's access to such data. Preferably, references to data include references to a set of data representing all versions of the data (where the data has been revised) or a specific, date-stamped version. Such functionality may be accomplished by writing data once, with appropriate ‘create date’ time stamps and references to and from the prior version of such data (with an appropriate ‘revised date’). This approach allows for referencing the data within the system as of any moment in time, allows for highly granular and accurate versioning and comparisons of versions of data. For example, this approach allows for comparing any version of a BFE contract with any other version (i.e., an amendment, draft or award) of that contract.

Within embodiments of the Guided Discovery system parties may use standard means to assign access, read, write and other rights to objects that have not been submitted to other parties. That is, they may designate who may view and manipulate objects, including in particular permitting objects to be “private” (i.e. Non-Discoverable, and therefore accessible only to representatives of the Parties, such as attorney-client privileged information), or made accessible to third parties (such as other Parties and Decision-Makers). In embodiments the process of assigning access rights follows industry standard means for assigning the access rights to objects and hierarchical folders (or other groupings), assigning Docs to such folder(s), or base access rights on rules related to the content or context—such as a “Discoverable” attribute or a rule indicating that amendments within a BFE that propose a settlement of a dispute are “Non-Discoverable”.

Parties may manage their discovery process as privately maintained objects, associated with each request, such that as Docs (with responses to questions considered Docs) are produced and Points asserted and responded to (i.e., Messages), the requesting party may more easily address each produced object. That is, by articulating Points and associating them with a discovery request, the party memorializes its original reason for the request (where appropriate), and thereby facilitating future computer-assisted organization of Docs as produced.

Parties may agree to impose Rules, or Rules may otherwise apply, to limit discovery, including by way of example limiting the total Points and Docs in a dispute, the total Docs permitted per Point, response times for points and penalties for non-responsiveness. If a party approaches the limits of discovery with respect to Docs, a party may “archive” (rescind) a Point, Doc or any combination or group of Points and Docs. Archived Points and Docs remain available to the other party, but typically are not made available to the Decision-Maker. Preferably, parties may maintain multiple drafts of Points, Docs and other data, and may group submissions to the other party for simultaneous ‘publication’, or review and approval using standard work flow means, with drafts preferably Non-Discoverable.

Consequently, a Tribunal process includes parameters impacting the Guided Discovery process: a) rules for discovery; b) potential limitations on the total points and Docs permitted, the time period for discovery, and/or other limitations. Such parameters may be agreed to by the parties in advance, during the alternative dispute resolution (ADR) proceeding, or specified by a third party such as the Arbiter (See for example, American Arbitration Association Rule E-6).

Tools in embodiments for reporting, sorting, filtering Points and Docs may include tools to facilitate organization and review. Statuses, such as open/closed, unread/read, response required, and user-defined tags used for user-defined organization may be used. Work flow functionality may be used to automate the review and approval process for any action that a party may otherwise take individually. For example, with respect to Points and Docs for a party (for example, a Doc may be entered into the system by a staff person, but require the approval of both an officer and counsel before submission to the system and availability to opposing parties).

Lists (such as permitted Responses within a given context) include items that may be selected (preferably allowing user-defined responses) and access business rules (such as when a Doc can and cannot be deleted) referenced in/by the systems may include system values, industry specific values, tribunal specific values, party or dispute specific values and combinations thereof.

Docs may be managed in the Guided Discovery system with functions, such as the ability to add, move, delete (unless barred by appropriate rules), rename and replace.

In an Internet-based embodiment of the present invention, an Internet website is set up to provide the interface between system and user. Preferably, the major areas of the website include a login area for parties or the party's representatives or attorneys, a login area for Decision-Makers, and a login area for administration personnel who oversee the system. If desired, the website may also include a publicly accessible area that highlights information about the system. For increased security, a separate website may be set up with this information.

Embodiments of the present invention may include a means to register and authenticate parties and Decision-Makers, with registration information (which may include name, address, email address and unique identifiers) that is stored in a storage medium. A user's session is initiated by logging into the site using an authentication means, such as a secured username and password or other current or future means of authentication. Roles and associated permissions for users of the system, such as those that are parties and Decision-makers are assigned by appropriate administrative users of the system on a per dispute or other basis for actions each user may appropriately take within the system, including appropriate information access by users within the system with regard to each dispute.

Individuals using the computerized system preferably must log into the system before they can manipulate any data. Preferably, users can view, enter and change only that information that is within their access limits as a party, Decision-Maker, or a system administrator.

Embodiments of the invention encourage dispute resolution through the use of guided messaging by facilitating the articulation of Points. To encourage the articulation of Points, Parties may optionally be required to make responses that state their positions on each Point, but need not stipulate or concede any point; that is, they may disagree, but are discouraged and potentially penalized by Rules for failing to provide a meaningful response. Such a penalty could include changes in fees, presumptions permitted of a Decision-Maker or other appropriate remedies. Additionally, Rules may permit automated resolution of disputes, where Points represented by logical propositions lead to a logical conclusion of the dispute. This may include agreement by the parties, as part of the process of engaging in Guided Discovery, with respect to all or less than all Points and/or Decision-Maker resolution of those points at such times permitted by the System applying Rules. Enforcement of required responses can vary with context, including by way of example being a factor in a Decision-Maker's award of attorney's fees, automatic stipulation to an opposing Point after a specified time period, or barring features such as articulation of new Points by the non-responding Party until timely responses are made.

In embodiments, an example of a response may be the proposal by one party to all other parties to close discussion of a Point prior to reaching any Rule-imposed limitations. Such a proposal preferably would include a proposed status for the Point, and a reason. Table 1 identifies preferable resolutions of a Point, in each case optionally with each party or the parties collaboratively identifying supporting Docs to be published to the Decision-Maker.

TABLE 1
Preferred Statuses for Closed Points

| Status | Status Meaning | Examples |
|---|---|---|
| Agreed | Point agreed upon by the Parties | The identified Doc fairly |
| | | represents the Point that there is |
| | | damage. (“This is a picture of the |
| | | damage”, “This picture shows |
| | | damage existing prior to |
| | | commencement of work”) |
| | | Optionally including a |
| | | Relationship to the picture (a type |
| | | of “Doc”). |
| Agreed, | Conditionally stipulating to a Point, with | This picture shows damage |
| Conditionally | one or more party adding clarifying | existing prior to commencement of |
| | comments required to be presented with | work discussed in the Point, But, I |
| | the stipulation. | did not cause the damage. |
| | | Optionally including a |
| | | Relationship to the picture (a type |
| | | of “Doc”) and ideally including a |
| | | Relationship to the prior message. |
| Denied | Denying with or without comment the | This is not a picture of the work |
| | Point of another party, with the other | area or damage caused, for the |
| | parties optionally offering alternative | following reasons. |
| | Points representing their proposed | Optionally including a |
| | conclusion to an issue. | Relationship to the picture (a type |
| | | of “Doc”) and ideally including a |
| | | Relationship to the prior message. |
| Replaced | A Point that the parties agree is replaced | This Point better defines the |
| | by another Point. | identified Point. |
| | | Ideally including a Relationship to |
| | | the prior message. |
| Disregarded | Disregarded | This Point is not relevant. |
| | | Ideally including a Relationship to |
| | | the prior message. |
| Related | This point is related, or supports [or | This is the same situation, at a |
| | contradicts] this other point. | different time. |

It is noted that Table 1 demonstrates that the technical nature of a Relationship and logic associated with a Point may be hidden behind friendly, plain language presentations and user interfaces.

As part of the discovery (pre-decision) process, parties may propose that a Point requires proof submitted as a Doc (providing an automated form of interrogatory using current and future means to generate questions and other requests, and receive and store responses to such questions and requests (see for example, surveymonkey.com)), and more generally request Docs (submitted for access by the parties, not necessarily associated with a point, and optionally not accessible to the Decision-Maker unless “Published” by the parties). Such requests may be limited under the applicable Rules. Proposed requirements may optionally appear to the parties as task lists, questionnaires and other means, with optional deadlines defined by Rules, providing a means to manage requirements within the system. Similarly, data representing deadlines and other tasks within the system may be transmitted to, synchronized with or access to such data may be provided to tickler, project management, calendaring or other systems through Interfaces. Optionally, Rules may also permit Decision-Makers to review discovered Docs not published by a party to the Decision-Maker, or to request (generally by the same means available to the parties, but optionally also at face-to-face, telephonic or other ‘hearings’) supplemental information.

In embodiments a tribunal process may be conducted where Decision-Makers participate in the resolution of a dispute by becoming a user provided access to the Guided Discovery system and optionally, a BFE system. Optionally, Decision-Makers are limited to selected content approved by the disputing parties, a process encouraged by Commerce Rules that charge for the quantity of content, or content in excess of pre-determined limits. For example, a specific dispute might be limited to 3 pages of Docs and 3 Points, with 1 page of discussion in support of those points. Additional pages of Docs and/or Points could be subject to additional fees.

Optionally in embodiments, as Rules permit, Decision-Makers may browse Points, express opinions and ask questions about Points to one or more parties (optionally permitting ex parte communications), or pose new Points for response by parties. Decision-Makers may use the Message System to internally record private notes or conclusions, and optionally associate such notes or conclusions with Points or Docs, and optionally publish such notes or conclusions for comment by the parties or other Decision-Makers.

Optionally in embodiments, Points may be submitted requesting changes in any Rule (such as a discovery limitation), with Decision-Makers deciding such Rule “Points”, and optionally assigning costs to such changes.

Embodiments may be integrated with BFE or another contract management or payment processing systems, Decision-Makers may enter judgments within such tools, which may include modifications to agreements, entry of monetary rewards, timing of payment of rewards, or other terms as such systems and Rules permit. Preferably, such systems would provide consistent treatment of disputes so that resolutions within the Guided Discovery system ensures proper recording of dispute resolution in other systems. Such coordination would be handled by an Interface, relying on the state of a dispute and its unique identification.

Points may be resolved through external means, such as the resolution of monetary disputes through online dispute resolution Web sites (i.e., U.S. Pat. No. 6,330,551 (Bruchetta et. al.)

Ultimately Decision-Makers reach Point Conclusions and related actions described herein. Where there are multiple Decision-Makers (such as a three person arbitration panel) the system may optionally permit majority (or other) votes on an agreed upon award, specific Point Conclusions or combinations of awards and Point Conclusions, based on the applicable Rules. Preferably, a single set of Point Conclusions and amendments (within the context of a BFE) would be agreed upon by the Decision-Makers.

Embodiments of the Guided Discovery system permit categorization of Points based on uniform sets of Rules, tags, keywords etc., and similarly, data within a BFE or other system may be used to categorize commonly occurring circumstances of a contract management and other disputes, such as the appropriateness of specific terms given a general or specific context. Such categorization enables the forming relationships between an issue (within the Guided Discovery system a Point) of like and unlike parties, permitting the automated identification of persons facing or who have faced similar circumstances (including circumstances arising within a BFE or any other context-specific system) or Points, and self and automated identification of groups of individuals (“Experts”) through profiles that identify skills and experience using similar categorization techniques, with respect to general or specific circumstances that may arise within the Guided Discovery system or other system. Thus, based on historical data the present invention permits the identification of other users of the Guided Discovery System (and optionally external interfaced systems such as a BFE) who have faced similar situations. This capability permits the system to introduce such persons, optionally anonymously, to provide assistance, a so-called “Reality Check”

In embodiments this “Reality Check” may include:

a) The means for an “Asker” user of the system to interactively select one or more factual circumstances within the subject system (i.e., selection of a Point within the Guided Discovery system, or the terms, prices, deliverables or materials with a BFE system);
b) A standard means to search (text, image, semantic or otherwise) historic data to produce a set of individuals with perfect or imperfect matching factual circumstances, preferably including certainty ‘weights’ to prioritize the quality of each match, including by way of example, user-provided scores, and the quantity of experience with each match;
c) Preferably, present a selection of individuals with a presentation of data concerning the match, that may be selected, optionally with the system and each individual determining what, if any, personally identifiable information is presented about the individual.
d) Optionally, searching profiles of ‘experts’ to provide potential matches, and optionally presenting the results of such search for selection of individuals.
e) Optionally, permitting each party to the Reality Check communication to first consent to be engaged in such communication;
f) Facilitating through Messages questions related to the factual dispute or other circumstance by the Asker, and responses from the selected individuals,
g) Optionally including a means for an ‘expert’ individual to collect agreed upon fees, “kudos” or other recognition for providing advice.
h) Preferably, allowing the Asker to grade the relevance and other attributes of responses by a responder, for later reference by Askers and use in calculations of prioritization.
i) Optionally, where fees are incurred, to note data associated with any dispute with regard to such fees.
j) The means to collect and disburse fees.

As previously described embodiments of the Guided Discovery provide a means for parties to engage in documented discussions of Points and reference Docs. The discussions may be as basic as commonly used threaded discussions. Preferably, these discussions categorize at each step the nature of the content presented by a party, and maintain statuses with respect to each Point. The following are embodiments of screen shots of a user interface (UI) with respect to a Point between a customer and a contractor.

Contractor Makes a Point:
Screen 1: Applicable Law Point
Party Optionally Selects a “Point: category “Applicable Law”
Selects “Florida”
By signing below, you are stating your good faith belief
that the Applicable Law for this Dispute (ID # )
is Florida. [Signature Means]
Screen 2: Customer responds to the Point (having been alerted to
an open, new issue)
Selects “Disagree” from a choice of Agree, Disagree, other (Agree with
clarification, propose replacement Point, or propose disregarding Point).
Party selects “Disagree”
[ ] Propose Closing Point
Screen 3: Customer provides required statement for Disagreement
Provide Rationale [ ]
Select Alternative if known [Georgia]
By signing below, you are stating your good faith belief
that the Applicable Law for this Dispute (ID # ) is Georgia.
[ ] Propose Closing Point
[Signature Means]
. . . further discussion
Screen 4: Contractor Proposes Closing Point
Selects “Agree” with respect to Customer's Point
(Georgia) from a choice of Agree, Disagree, other (Agree with
clarification, propose replacement Point, or propose disregarding Point).
You may identify this issue as closed, or request a response from
Contractor.
Additionally,
You may modify your Point.
You may submit Docs in support of your position.
You may send messages to the other party
[x] Propose Closing Point
By signing below, you are (a) stating your good faith belief
that the Applicable Law for this Dispute (# ) is not Florida, but
is Georgia; and (b) Propose closing this Point. [Signature Means]
Hint: you may return prior to submission to the [Mediator, Arbiter]
to clarify your response. (This feature may be available or not depending
on the applicable limitations and set parameters for discovery)
Screen 5
Customer Responses agreeing to closing the Point.
By signing below, you are (a) stating your good faith belief that the
Applicable Law for this Dispute (# ) is Georgia, not Florida; and (b)
Agree to closing this Point. [Signature Means]

The following is an example Form “Pleading” for Construction Delay or Poor Workmanship:

Proof of Contract—Party identifies or provides as a Doc a proof of a contract. With respect to BFE contracts that are disputed, initiation of the dispute referencing a signed contract within a BFE provides proof of contract. Parties may also provide as a Point, supported by Docs, evidence of oral agreements.

Work Item List: A Point or Points grouping together work items (as data or Docs, or Relationships to them) you assert the contractor did wrong, did not finish or did not start. Each item optionally forms a Point and can be substantiated by Does. With respect to BFE signed agreements, this work item list may be provided by reference(s) to milestones, deliverables or other data or metadata electronically represented in a BFE.

Delay: Where a deadline is established in the agreement or in BFE-signed agreements, the parties may reference deadlines stated in the Doc, preferably data or metadata within the Doc, as proof of the deadlines.

Party's may raise Points disputing the admissibility of Docs and Points. For example, Docs or Points that contain confidential information of one party (such as a settlement offer introduced by such party) that is added as a Doc by the other party would appear to the system to be admissible. The admissibility of that information would be raised as a Point, and, and during such process, the contents may be hidden (or not) from Decision-Makers based on Rules.

Rule Sets preferably are represented, stored and processed as XML documents, and standard Rule Sets may be adopted and made available by courts, arbitration associations and other decision-makers, such that uniform practices for Guided Discovery may be implemented.

Publication or distribution of a rule set may be centralized, stored in multiple locations, and may be subject to license fees for use. The system preferably would handle use-based license fees through a process of registration of the Rule Set and licensor of the Rule Set, specification of the license fee schedule and then managing collection of the license fee as a precondition of using the System's use of the licensed Rule Set. License fees may be per use, per block of uses, unlimited use for a period of time or by particular parties, and any other means of allocating use of the Rule Set(s).

The following table is not intended to be an exclusive means of representing Rules within the Guided Discovery System but rather to be illustrative of the preferred means of organizing Rules.

| Rule Category | | |
|---|---|---|
| Decision-Maker | Amend BFE Contract | |
| Authority | as Award | |
| Decision-Maker | XML representing | May be implemented |
| Authority | flexibility to modify | as separate data within the |
| | Rule Set. | Rule Set or as parameters |
| | | ‘locking’ or ‘unlocking’ rights |
| | | of the decision-maker to |
| | | modify all or specific rules or |
| | | classes of rules. Each rule |
| | | may also impose limitations |
| | | on the Decision-maker's |
| | | authority, such as for a time |
| | | limitation initially stated as 5 |
| | | business days, allow the |
| | | decision maker to extent up to |
| | | 10 days, but not reduce with |
| | | minimum values (5) and |
| | | maximum (10). |
| Decision-Maker | XML representing | Parameters include the |
| Authority | the requirements of | number of decision-makers, if |
| | the decision-maker | more than one, how decisions |
| | | are rendered (i.e., majority |
| | | vote), whether awards must be |
| | | a proposal by the parties, or |
| | | may be determined in the |
| | | decision-maker's discretion |
| | | (and if so, any limitations on |
| | | discretion) . Decisions may be |
| | | about specific points, groups |
| | | of points, restricted to a final |
| | | award or other means of |
| | | organizing the process of |
| | | decision-making for the |
| | | specific context. |
| Decision-Maker | XML representing | The parties typically |
| Authority | the decision-makers | present information to a |
| | right of access to | decision-maker. These |
| | information. | parameters determine the |
| | | decision-makers authority or |
| | | lack of authority to use other |
| | | data sources, including Docs |
| | | and Points created during the |
| | | Guided Discovery process but |
| | | not published by a party to the |
| | | Decision-Maker, and the |
| | | Decision-Maker's authority to |
| | | require hearings (telephonic, |
| | | in person, on site or otherwise) |
| | | or request Docs, or, preferably |
| | | because of lower costs, |
| | | limitation of only performing |
| | | “OnTheDocs ®” documents- |
| | | only decision-making. |
| Decision-Maker | Authority | Binding (i.e. court or |
| Authority | | binding arbitration)/Non- |
| | | Binding (i.e., mediation |
| | | requiring consent of parties to |
| | | become binding) |
| Decision-Maker | Authority to issue | Determines the |
| Authority | surcharges or | decision-maker's authority to |
| | issue negative | impose surcharges, and, if not |
| | “points”. | timely paid, specifies the |
| | | decision-maker's authority to |
| | | prohibit one or more rights of |
| | | a party to use the system (such |
| | | as the right to publish Docs, |
| | | respond to Points and |
| | | participate in hearings), or |
| | | authority to consider such |
| | | non-cooperation when |
| | | determining reasonable |
| | | attorneys fees or other relevant |
| | | portions of an award. |
| Decision-Maker | Authority of | Allows Decision- |
| Authority | alternative | Maker authority Rules to be |
| | decision-makers. | applied to multiple Decision- |
| | | Makers based on specific |
| | | objective criteria, such as an |
| | | Arbitrator, for most purposes, |
| | | but an automated negotiation |
| | | tool (i.e., CyberSettle.com) |
| | | where only monetary Points |
| | | remain outstanding. |
| Party Authority | User with authority | [Default work flow is |
| | to accept settlement | single user approval or |
| | | disapproval, and optionally |
| | | may include request for |
| | | clarification]] |
| Party Authority | Work Flow data* | [Optional, Leading to |
| | | approval or disapproval, and |
| | | optionally may include request |
| | | for clarification] |
| Party Authority | Ability of parties to | Preferrably permitted, |
| | agree to Rule changes | to modify all or specific rules |
| | | or classes of rules. Each rule |
| | | may also impose limitations |
| | | on the party's authority to |
| | | agree to Rule changes. |
| System | Automated authority | Defines the system's |
| | | ability to automate decision |
| | | making based on the logical |
| | | consequence of the party's |
| | | agreement on Points. |
| | | Preferably, such automated |
| | | means would include a notice |
| | | period and opportunity for the |
| | | parties to modify their respond |
| | | to Points or to raise new |
| | | Points. |
| System | Work Flow data | Optional work flow |
| | | data to manage automated |
| | | actions related to an approval, |
| | | such as releasing liens, |
| | | implementing payment |
| | | transactions, implementing |
| | | adjustments to escrow |
| | | accounts. |
| Commerce Rules | Rules determining | Typically, such rules |
| | costs | lead to calculations by |
| | | reference to data in or |
| | | accessible to the Guided |
| | | Discovery System. These |
| | | rules also may provide for |
| | | different fee arrangements for |
| | | specific contexts, such as |
| | | consumer-merchant disputes. |
| | | Preferably, fees are based on |
| | | the amount of content |
| | | published to the Decision- |
| | | Maker. |
| Commerce Rules | Rules determining | |
| | access to system | |
| | based on payment. | |
| Commerce Rules | Penalty Surcharges | Fee schedules for |
| | | surcharges, preferably |
| | | escalating as negative ‘points’ |
| | | accrue against a party. |
| | | Negative points accrue |
| | | automatically for failure to |
| | | meet deadlines or other |
| | | objective criteria within the |
| | | system (if a point value is |
| | | associated with such criteria in |
| | | the Rule Set), imposed by a |
| | | decision-maker (if permitted). |
| Commerce Rules | DOC submission | May be used to |
| | limitations | optionally limit types of |
| | | content, quantity of one, more |
| | | than one or all content. |
| Discovery Rules | Limitations | I.E., limitations on the |
| | | number of points that may be |
| | | raised, Docs that may be |
| | | submitted to the other party, |
| | | interrogatory and Doc requests |
| | | permitted by one party of |
| | | another party, and time |
| | | limitations for requests, |
| | | responses to each type of |
| | | message or action. |
| Data Retention | Rules for retention | I.e., at what point the |
| Rules | by the System of | system deletes permanently |
| | Data related to a | private notes of a decision- |
| | decision. | maker not published to the |
| | | parties. |

*All references to Work Flow and Work Flow data may be implemented using any current or future work flow means, preferably represented by XML data. Where XML is referred to other forms of storing and representing data may also be used.

BFE systems employed in embodiments may provide for the ability of any party to propose amendments to agreements at any time, which are binding only if signed as described above. Such amendments may include a term(s) indicating that a Dispute has been resolved, resulting in the resolution of such disputes once an amendment becomes effective by mutual assent of the parties, typically evidenced by electronic signatures. Decision-Makers with appropriate authority under the specified Rules may unilaterally impose amendments to agreements or new agreements between the parties, in each case identifying disputes resolved by such actions thereby effectuating the Decision-Maker's judgments within a system that also can manage and enforce performance of the judgments as agreed upon by the parties as part of the alternative dispute resolution rules.

In embodiments, disputes are considered “Open” until resolved through the amendment process or other means described herein. A BFE System may include roles assigned to third parties, such as Decision-Makers, who may propose or dictate amendments, as context warrants. For example, a mediator may propose an amendment to an Agreement via a BFE, in which case all parties to the relevant agreement would be required to sign such amendment to bind them to the mediator's proposal. Similarly, a judge or arbiter (in binding arbitration) may Decision, or publish such Decision to the parties for discussion prior to dictating its binding nature. In any event, a “Decision” regarding a contractual dispute eventually may become an amendment (such as a BFE-originated amendment) to the applicable contract(s), and any legal dispute may result in Decision in the form of a settlement award or other means of identifying the resolution of the dispute (together an “Amendment”) that is binding on the parties without the additional assent of the parties required for party-proposed or mediator-proposed amendments. In each case, the foregoing amendments (arising from Decisions) may be automatically binding, or subject to standard processes (preferably, standard work flow techniques) for comment, appeal and following pre-determined rules, such Decision would bind the parties. Such work flow may also manage required filings (i.e., entry of judgment and releases of liens), notices or other steps necessary to properly effectuate the amendment or Decision, the requirements for which are determined by metadata or data within the BFE, Guided Discovery or other systems Interfaced thereto. For example, a BFE may manage construction contracts including lien filings, providing the context to automate the release of liens once applicable contracts are satisfied. Such capabilities are implemented by appropriate business rules and permissions within a BFE, preferably, “Arbiter” and “Mediator” roles providing access to published content (i.e., Points, Docs (each defined below) and other objects) related to a dispute, and rights to read, modify and as appropriate impose, propose or otherwise make known the changes and new terms, including by way of example payment terms.

In embodiments, a BFE preferably models agreements as data, preferably including an extensible markup language (“XML”) representation of such data, and stores Does through standard means, again preferably including an XML representation where appropriate. It is noted that other computer scripts or languages may be used to represent or model agreements. A simple agreement model implemented in a BFE, may include any agreement specific data: identification of materials and deliverables, including type (selected from a stored and revisable list of selections), part numbers, quantity, delivery location and delivery dates), standard written terms of agreement, and user defined fields (such as party names, means of providing notice, representatives of parties, effective dates), and payment and escrow terms, including timing of payment in relation to parameters such as initiation of work on a deliverable or milestone, delivery of deliverables or milestones, acceptance by customer of delivery or milestones, or the passage of time (specific dates, periodic payments, and other standard terms of payment).

The modeling of agreements in embodiments as XML documents provides flexible articulation of the elements of an agreement, their labels and processes to maintain such elements (i.e., entering, revising, removing, reordering and presenting the elements in a NCBMA, via Interfaces (defined below)). The ability to uniquely identify and refer to elements of an agreement, including elements created during the performance of the agreement, enriches the dispute resolution process, and also provides for means to analyze multiple disputed outcomes by, for example, comparing a set of proposed and binding agreements, and research on the characteristics of agreements that lead to disputes. Similarly, embodiments of the present invention may be used in conjunction with any NCBMA that uniquely identifies data that may be the subject of a dispute. That is, the present invention may be used not only for contractual disputes but in conjunction with any NCBMA that processes data for which the present invention may facilitate Decision-making.

While a BFE is preferably part of the present invention for disputes involving contractual relationships, a BFE may operate independent of a dispute resolution system such as the present invention. Embodiments of the present invention may act as a tool to facilitate the discovery of dispute-related information, present that information in useful ways to persons engaged in the dispute resolution process, and promote and guide the prioritization of that information, grade the reliability of that information, and or focus collaborative and communications on reaching specified goals for such information, such as the conclusion or failure to reach a conclusion on a factual, legal or technical issue. Consequently, while embodiments of the present invention include as an option Interfaces with a BFE, project management system, or other external system, the present invention more generally facilitates the resolution of contractual and other disputes or questions whether or not Interfaced with or into a BFE system or process. Disputing parties may utilize embodiments of the invention for facilitating the resolution of their disputes, for example, which arise from a paper-based contract. Such paper-based contracts may include issues (or the parties to that contract or other dispute may nevertheless later agree to terms) requiring mediation, arbitration or, as permitted by regulatory bodies or courts, and may include the requirement of the use of the present invention to resolve the issues and referring to specific sets of Rules and/or specifically modifying those Rules in permitted ways. In such circumstances, a party would initiate the dispute directly within the Guided Discovery system rather than from within a BFE system or by referring to objects within a BFE.

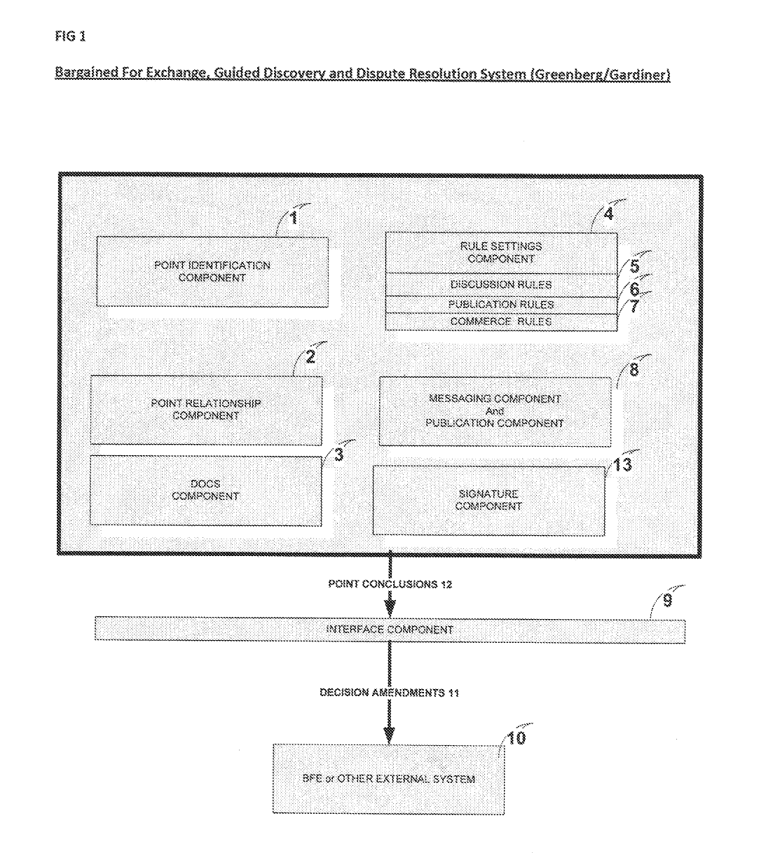

Referring now to the figures, FIG. 1 is a block diagram of components of a Guided Discovery NCBMA according to embodiments of the invention. As shown in FIG. 1, a Point Identification Component 1 is used to manage and articulate Points. Points may include a text proposition, logical proposition relating data or Docs available to the parties, or other metadata representing a fact or idea. Points preferably are categorized using standard categories and subcategories (to any level of specificity of categorization), tagged with keywords, or grouped (for example into folders, or hierarchies of folders). Logical propositions represented as part of a Point provide additional means to organize Points and Docs, including by presenting logic maps, showing the interrelationship between Points and optionally demonstrating the conclusions that can be reached based on the party's relative positions with regard to the relevant Points. Categories may be used to act as a reference or knowledge base or templates of potential Points to raise, may be used to provide guidance in the form of form “pleadings” made up of a sets of categories, and expert and other intelligent systems design to interview parties and recommend Points to the parties based on the context of the dispute available to the system.

A Docs Component 3 provides a means for managing, storing, organizing, retrieving, referencing, categorizing and/or managing access to Docs. Optionally but preferably, Docs include references to identifiable information within a BFE system, such as specific agreement terms, deliverable, Non-Discoverable or Discoverable Content.

In embodiments, Points and Docs may also be grouped for organizational purposes using standard means such as folder hierarchies, categories, tags or keywords, a search criteria using standard means (referred to as ‘view’ of the available objects and their related metadata), or a combination of these or other standard means.

A Relationship Component 2, provides a means to identify relationships between Points and Docs, and any number of other Points and Docs, such that there may be a many-to-many relationships between any objects (Point or Doc and other Points and Docs, or Groups thereof). Preferably, Relationships are a special or abstract case of a Point, since a stated Relationship itself is an assertion of the relationship between objects, subject to discussion, proof etc. Relationships further may take into consideration versioning of Docs and Points, allowing Relationships with a specific version of a Doc or Point, the then-current version of a Doc or Point, or permit selection of versions for purposes of discussion. The simplest relationship may be a standard hyperlink (e.g., a party may reference a Point made by another party on a specific date/time, even if the other party later modified that Point).

Relationships between objects may be labeled to provide additional meaning and context. For example, Documents may form relationships to relate to Points with properties including, by way of example: (a) a Doc may support or negate a Point (optionally with weights, such as a percentage of value in a range, indicating the degree of support); (b) a Doc may be similar to another point (optionally with weights, such as a percentage of value in a range, indicating the relative similarity); (c) that a Doc should be viewed with one or more related Docs (identified as a Relationship); (d) a Point is supported by a Doc; (e) a Point is related to another Point; (f) a Point has a logical relationship to another Point (discussed in the following paragraph).

A Relationship thus includes unique identifiers for two or more objects, optionally including data representing one or more Points. A Point in such context may be expressed as logical propositions, such as Point 1 is true only if related Point 2 is true; Point 1 is true only if (all, at least one) of a related group of Points is true; Doc 1 supports Point 1. These logical propositions may include other logical predicates using standard means (i.e., and, or, not, xor), including through standard means such as the Prolog computing language.

Continuing with FIG. 1, Rule Settings System 4, includes Discussion Rules 5, for managing and storing business rules and data for limiting and guiding Guided Discussions, Publication Rules 6, for identifying a subset of Docs, Points and any other information, managing and storing rules related to determine the format, organization, presentation, and contents of, the publication of all Docs, Points and any other information or data, and Commerce Rules 7 for business rules used to calculate Decision-Maker or other fees and costs. Rules of the Rule Setting System 4 include the work flow, conditional branching, and states associated with Points and Docs. Preferably, the Rules Setting System 4 permits Rules to vary based on context, such as variations based on the nature of a dispute, the type of tribunal, type and number of Decisions-Makers, geographical location, applicable law (for legal disputes), and otherwise based on values available. Preferably, the Rules may be further defined by context as the dispute progresses. For example, the applicable law might not be known at the initiation of a dispute, and may be raised as a “Point” leading to a “Point Conclusion” providing for applicable law that might lead to additional context, and therefore changes in the applicable Rules. Another example is that Commerce Rules 7 and other Rules change based on the character of the parties as consumers or commercial parties. Rules also may define other optional behaviors of the system relevant to a dispute, such as the types of actions that maybe associated with a Message, and how Points, Docs and Relationships are categorized.

Messaging Component 8, provides the means to manage communications related to Docs, Points and relationships, along with related metadata and user-supplied commentary. Messages also may include proposed actions such as the proposed closing of a Point, or the agreement to do so in response to such proposal. By facilitating communications and actions geared to move parties towards conclusions (ultimately the closing of a Point), the Messaging Component 8 guides the parties towards stipulations of their positions, questions, or creating or identifying other Points by applying Rules. Limitation Rules and other Rules available to Decision-Makers further encourage efficient, cooperative responses.

Messaging may be accomplished through any communication means, including by way of example, presentation through a website, email, text messaging, fax, voice, video or other recording, or voice-to-text. Messages that by their nature require no response by a third party (such as internally generated notes) or only automated responses may be stored in a storage means without communication. Preferably, the Messaging Component provides an online user interface to guide users' interaction with the system as limited by the Rules. The online user interface additionally provides the means to browse and organize Docs and Points (and their relationships), with tools appropriate to the parties role (i.e., party to the dispute, third party assisting or providing information with respect to the dispute, third party data sources, and Decision-Makers). Messages may include Points, Docs, other messages, and other data stored within the systems, or references to them.

Interface Component 9 provides a means for Guided Discovery to interface with external content and systems 10, such as a BFE System. Such interfaces provide advantages by allowing the external content and systems 10 to facilitate identifying specific issues in agreements (or other content/contexts) or other references. By allowing external systems 10 the capability to raise Points and create Docs, and Relationships between them and other Points and Docs within the Guided Discovery system, the Interface Component 9 provides a means for highly granular, information-rich, timely, context specific dispute resolution. The added context such external systems provide assists parties and Decision-Makers in understanding quickly the nature and context of a dispute, and allows the Guided Discovery system to organize quickly the Docs, Points and Relationships, and resulting decisions, awards, judgments or settlements. The Interface Component 9 further allows for Point Resolutions to cause changes in behavior of the calling system, such as in the context of a BFE System, adding, modifying or otherwise changing terms of agreements (Decision Amendments 11) within a calling BFE or other external system based on Point Conclusions 12 of Decision-Makers. In particular, Point Conclusions 12 may lead to Decision-Makers gaining access to a BFE or other external system to specify Decision Amendments 11 and relate them to specific Point Conclusions 12.

Publication Component 8, a special application of the Messaging Component 8, provides the means to select, organize, quantify (to permit enforcement of word, page or other limits) and provides access to the Points, Docs and Messages that each party desires the Decision-Maker to consider in rendering Point Conclusions. The publication process may be “blind”, with each party submitting their own selections, “iterative” with multiple (preferably limited) rounds of “blind” submissions, additive (by adding new content subject to Limitations Rules and Commerce Rules) or collaborative, depending on circumstances. These publication processes may include locking in submissions, but permitting additional submissions, or revision of prior submissions. Rules may apply to determine limits of submissions by each party in aggregate, or in each round for interactive processes. Commerce Rules may apply to quantify costs associated with submissions, and may discourage counterproductive behaviors that arise in the system. Such Commerce Rules may include, by way of example, total pages, total words, total Points, and may weight differently pages, words, Points submitted by multiple parties. The per-unit fees associated preferably increase, optionally after a threshold quantity, with the number of units of content increases.

Signature Component 13 provides enforceable current and future means to secure electronic assent of parties where appropriate, such as parties mutually agreeing to a Point Conclusion for a Point in a context that requires legally binding agreements, a settlement, the selection of a Rule Set or changes in Rules, and Decision-Maker awards (etc.) and votes.

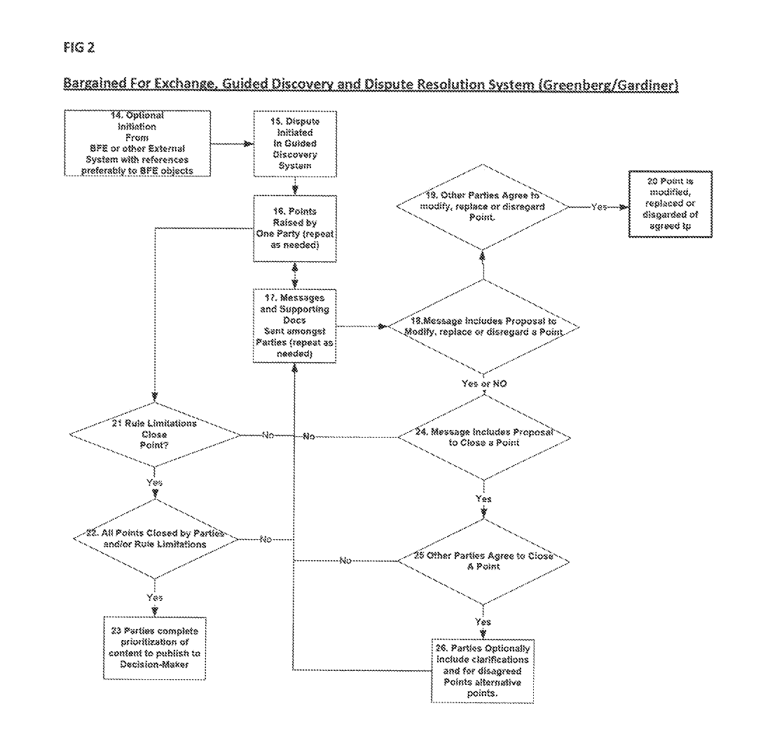

FIG. 2 is a flowchart illustrating the initiation of a dispute within or by the Guided Discovery System of an embodiment of the invention. The dispute resolution process starts initiation within or by the Guide Discovery System (Block 15), or optionally the dispute resolution process initiates from a BFE or other external system of a dispute (Block 14) with optional references preferably to BFE objects, and optionally a user through a BFE may raise Points and identify agreed-upon Rule limitations, in each case via an Interface or other means such as externally stored Rule Sets (FIG. 1, at 10). Next, each party identifies factual, legal or other logical “Points”, optionally subject to Rule limitations (Block 16). The parties may continue to identify Points subject to Rule limitations. Subsequently or in parallel, the parties engage in discussions (Block 17) through the Message Component 8 (see FIG. 1), and manage and reference supporting “Docs” through the Docs Component 3. At Block 18, a Message optionally includes a proposal to modify, replace or disregard a Point; and Block 19 provides for the agreement with respect to such message leading to the modification, replacement or disregarding of such point at Block 20. At Block 24, a message optionally includes a proposal to Close a point. The case of each such proposal, the parties must agree to such Proposal, for example, at Block 25 or agree to disagree, each stating one or more alternative resolutions of the point. At Block 26, the parties may clarify their position with respect to a closed Point by offering an alternative Point or clarifying text, including supporting Docs. At Block 21, Rule limitations may result in the automated closing of a Point (i.e., a time deadline). Note, the parties may raise as a “Point” the modification of a Rule limitation, which is then decided by a Decision-Maker. When the Decision-Maker Closes such a Point, Rule limitations may be modified for a specific case (i.e., more time or more space for a specific Point) or more result in a more general change in a Rule Set. If at Block 22 all Points are closed by agreement of the parties (all parties unless Rules permit otherwise) and/or Rule limitations, then the parties and/or the Decision-Maker organize and prioritize the content (Points, Docs etc.) to publish to Decision-Maker (Block 23). Typically, such published content is the sole content reviewed by the Decision-Makers, although the Rules may permit additional content, requests for content by Decision-Makers, and in-person or remote hearings.

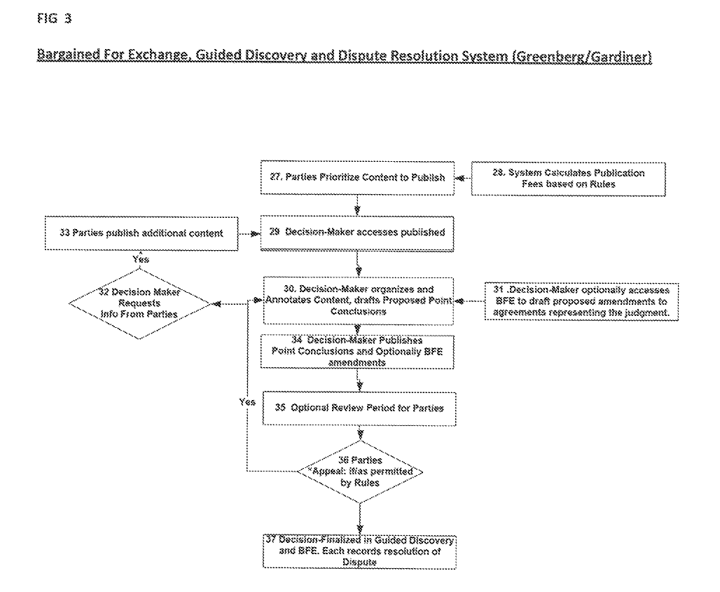

FIG. 3 is a flowchart illustrating the decision making process carried out by Decision-Makers according to an embodiment of the invention. The Decision-Maker may begin to carry out the decision making process following the Parties to the dispute prioritizing content relevant to the dispute and publishing the content (Block 27) for the Decision-Makers to view. In Block 28 the system optionally bases fees on the quantity and other characteristics of the published content, preferably applying fee schedules that penalize submissions in excess of an agreed upon or imposed minimum quantity to be submitted to the Decision-Makers. To facilitate understandability of such fees schedules, the system preferably calculates equivalent units (such as pages) for each type of data/Docs submitted to the Decision-Maker, by or between the parties or managed by a party. At Block 29, the Decision-Maker accesses the published content, and at Block 30 optionally organizes and annotates the content, and drafts Proposed Point Conclusions. At Block 31, the Decision-Maker optionally accesses a BFE, via an Interface 9 (see FIG. 1) to draft proposed amendments to agreements representing the judgment. At Block 34, the Decision-Maker publishes the Point Conclusions and optionally BFE amendments. At Block 35, the Rules may permit the parties an opportunity to review the Conclusions and optional BFE amendments, and at Block 36 appeal as permitted by the Rules, and/or reinitiating the Decision-Making process at Block 30. At Block 32 and Block 33, the Decision-Maker may request additional content from the parties, initiation steps in FIG. 2, and returning the Decision-Maker to Block 29 in FIG. 3. At Block 37, a final decision is recorded in the Guided Discovery and optionally BFE systems, and communicated to the parties. The final decision is then used as a basis for action by the parties to the dispute to enact the decision. Representative modes of enactment include a transfer of money, personal property, real property, remediation of damage, and combinations thereof. The Guide Discovery system may also be applied with Decision-Makers deciding Points incrementally, as presented or in groups or phases, as appropriate for the type of dispute.

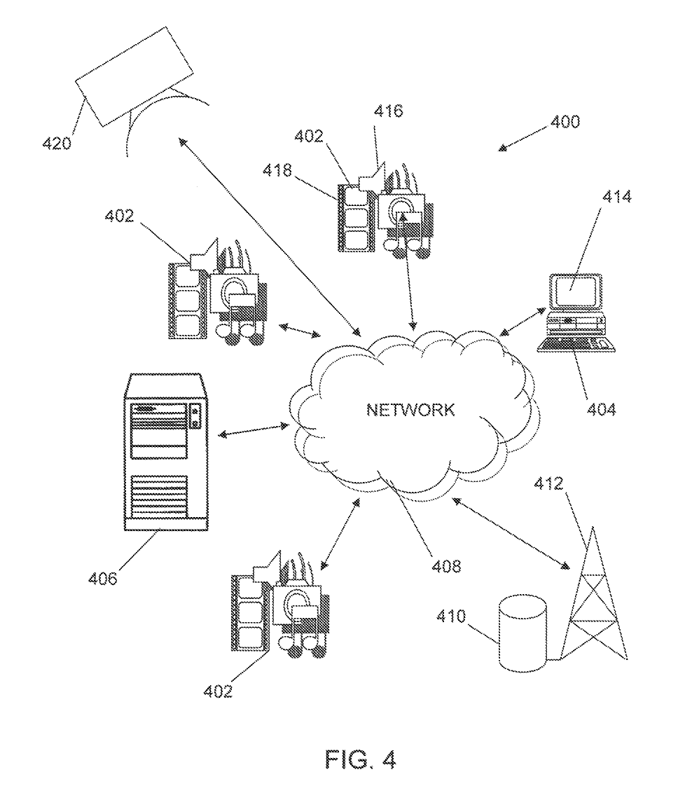

FIG. 4 is a schematic diagram illustrating an overall view of communication devices, computing devices, and mediums for a networked computer-based method and apparatus for computer-assisted discovery and tribunals for disputes involving multiple parties according to embodiments of the invention. The elements of the embodiments of the Guided Discovery NCBMA according to embodiments of the invention in FIG. 1 are included in the networks and devices of FIG. 4.

The system 400 includes multimedia devices 402 and desktop computer devices 404 configured with display capabilities 414. The multimedia devices 402 are optionally mobile communication and entertainment devices, such as cellular phones and mobile computing devices that are wirelessly connected to a network 408. The multimedia devices 402 have video displays 418 and audio outputs 416. The multimedia devices 402 and desktop computer devices 404 are optionally configured with internal storage, software, and a graphical user interface (GUI) for carrying out elements of the Guided Discovery system according to embodiments of the invention. The network 408 is optionally any type of known network including a fixed wire line network, cable and fiber optics, over the air broadcasts, satellite 420, local area network (LAN), wide area network (WAN), global network (e.g., Internet), intranet, etc. with data/Internet capabilities as represented by server 406. Communication aspects of the network are represented by cellular base station 410 and antenna 412. In a preferred embodiment, the network 408 is a WAN and each remote device 402 and desktop device 404 executes a user interface application (e.g., Web browser) to contact the server system(s) (e.g., Guided Discovery system of FIG. 1) 406 through the network 408. Alternatively, the remote devices 402 and 404 may be implemented using a device programmed primarily for accessing network 408 such as a remote client. The servers constitute a plurality of computing systems, with the terms server, computer and computer system broadly used to describe any computing device that can store and run one or more programs to implement method and system embodiments. Sequences of instructions of embodiments can be performed by a single computer system or server or two or more computer systems or servers coupled by a communication link, which serves as an interface to a communications network 408. The computer system can operate in conjunction with a data storage system, e.g., a data storage system that contains a database that is accessible by the computer system. The computer system communicates with the data storage system through a data interface coupled to a bus. The system transmits and receives electrical, electromagnetic or optical signals, that include data streams representing various types of signal information, e.g., instructions, messages and data. In embodiments, the functions of the data interface may be performed by the communication interface.

The software for the Guided Discovery system, of embodiments of the invention, may be resident on the individual multimedia devices 402 and desktop computers 404, or stored within server(s) 406 or cellular base station 410. Server(s) 406 may implement a cloud-based service for implementing embodiments of the Guided Discovery system with one or more databases and/or multi-tenant databases for data storage.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A computerized method for guided discovery and dispute resolution, said method comprising:
receiving via a networked connection one or more points from a series; of opposing members on a server, each opposing member corresponding to a party to a dispute, said dispute to be resolved with respect to said points;
conducting discussions between said series of opposing members with respect to said points;
sending messages between said series of opposing members to in response to requests from said opposing members of said series of opposing members, said messages proposing to modify, replace, close, or disregard a point from said one or more points;
modifying, replacing, closing, or disregarding said point in response to agreement between said series of opposing members;
receiving supporting documentation from said opposing members;
providing published information comprising the modified or replaced points as well as remaining original points from said one or more points to a Decision-Maker; and
providing said Decision-Maker's determination of an agreement with respect to said dispute to said series of opposing members; and
acting to enforce said agreement.

2. The method of claim 1, wherein said one or more points are subject to rule limitations.

3. The method of claim 1, wherein said discussions are threaded discussions.

4. The method of claim 1, wherein said discussions categorize the nature of content in a point presented by a party, and maintains statuses with respect to each Point.

5. The method of claim 1, wherein said agreement is provided as data in an extensible markup language.

6. The method of claim 1, wherein said supporting documentation is tagged for identification and retrieval.

7. The method of claim 1, wherein rules limit the number of supporting document submissions by each party.

8. The method of claim 1 further comprising: receiving clarification from a party with respect to a closed point by offering an alternative point or clarifying text, including supporting documents.

9. The method of claim 1 further comprising charging fees to said parties based on amounts of published information provided to said Decision-Maker.

10. A system for guided discovery and dispute resolution, said system comprising:
a server connected via a network to user devices for use by a series of opposing members, each opposing member corresponding to a party to a dispute, and to one or more Decision-Makers;
a memory system in electrical communication with said server containing a machine readable medium having stored thereon one or more sequences of instructions which, when executed, cause a method to be carried out, the method comprising;
receiving via said networked connection one or more points from said series of opposing members, said dispute to be resolved with respect to said points;
conducting discussions between said series of opposing members with respect to said points;
sending messages between said series of opposing members to in response to requests from said opposing members of said series of opposing members, said messages proposing to modify, replace, close, or disregard a point from said one or more points;
modifying, replacing, closing, or disregarding said point in response to agreement between said series of opposing members;
receiving supporting documentation from said opposing members;
providing published information comprising the modified or replaced points as well as remaining original points from said one or more points to a Decision-Maker; and
providing said Decision-Maker's determination of an agreement with respect to said dispute to said series of opposing members.

11. The system of claim 10 further comprising a Point Identification Component that is used to manage and characterize said points; wherein said points are categorized into categories and subcategories, tagged with keywords, grouped into folders or hierarchies of folders, or provided with logical propositions.

12. The system of claim 10 further comprising a Docs Component that manages, stores, organizes, retrieves, references, categorizes and manages access to said supporting documentation.

13. The system of claim 10 further comprising a Relationship Component that identifies relationships between said points and said supporting documents; and
wherein said relationships take into account versioning of said supporting documents and points.

14. The system of claim 10 further comprising a Rule Settings System for controlling work flow, conditional branching, and states associated with said points and supporting documents; and
wherein the Rule Setting System permits rules to vary based on context, such as variations based on the nature of a dispute, the type of tribunal, type and number of Decisions-Makers, geographical location, applicable law, and otherwise based on values available.

15. The system of claim 14 wherein said Rule Setting System further comprises Discussion Rules for managing and storing business rules and data for limiting and guiding said discussions.

16. The system of claim 14 wherein said Rule Setting System further comprises Publication Rules for identifying a subset of supporting documents, points and any other information, managing and storing rules related to determine the format, organization, presentation, and contents of, the publication of all supporting documents, points and any other information or data.

17. The system of claim 14 wherein said Rule Setting System further comprises Commerce Rules for business rules used to calculate Decision-Maker or other fees and costs.

18. The system of claim 10 further comprising a Messaging Component that provides managed communications related to said supplied documents, points and relationships, along with related metadata and user-supplied commentary; and
wherein said messaging is through at least one of presentation through a website, email, text messaging, fax, voice, video or other recording, or voice-to-text.

19. The system of claim 10 further comprising an Interface Component configured to interface said system for guided discovery and dispute resolution with external content and systems, such as a Bargained For Exchange (BFE) systems.

20. The system of claim 10 further comprising a Signature Component that provides enforceable current and future means to secure electronic assent of parties where appropriate, such as parties mutually agreeing to a point conclusion for a point in a context that requires legally binding agreements, a settlement, the selection of a rule set or changes in rules, and Decision-Maker awards and votes.
